(19) United States
(12) Patent Application Publication
(10) Pub. No.: US 2026/0099606 A1
(43) Pub. Date: Apr. 9, 2026

(54) Context Aware Pre-Boot Seamless Security Acceleration Protocol with Arm Trust Zone for UEFI Firmware Services

(71) Applicant: Dell Products L.P., Round Rock, TX (US)

(72) Inventors: Harish Barigi, Nellore (IN); Shekar Babu Suryanarayana, Bangalore (IN)

(21) Appl. No.: 18/905,338

(22) Filed: Oct. 3, 2024

(51) Int. Cl. G06F 21/57

(52) U.S. Cl. CPC G06F 21/575; G06F 2221/034

(57) ABSTRACT

A firmware management operation. The firmware management operation includes providing an information handling system with a distributed BIOS; identifying a processor environment installed on an information handling system from a plurality of processor environments, the processor environment comprising a processor architecture; and, performing a boot process secure execution environment operation, the boot process secure execution environment operation providing a processor environment context aware security environment.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed unified BIOS; identifying a processor environment installed on an information handling system from a plurality of processor environments, the processor environment comprising processor architecture; and, performing a boot process secure execution environment operation, the boot process secure execution environment operation providing a processor environment context aware security environment.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed BIOS; identifying a processor environment installed on an information handling system from a plurality of processor environments, the processor environment comprising a processor architecture; and, performing a boot process secure execution environment operation, the boot process secure execution environment operation providing a processor environment context aware security environment.

In another embodiment the invention relates to a computer-readable storage medium embodying computer program code, the computer program code comprising computer executable instructions configured for: providing an information handling system with a distributed BIOS; identifying a processor environment installed on an information handling system from a plurality of processor environments, the processor environment comprising a processor architecture; and, performing a boot process secure execution environment operation, the boot process secure execution environment operation providing a processor environment context aware security environment.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 shows a simplified block diagram of a boot process secure execution environment system of an information handling system (IHS); and,

FIGS. 6a and 6b, generally referred to as FIG. 6, are a simplified block diagram showing an architecture-specific distributed firmware management platform (ASDFMP) implemented in accordance with an embodiment of the invention to perform a boot process secure execution environment operation 600.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the invention reflect an appreciation that it is known to provide information handling systems which include Advanced Reduced Instruction Set Computer (RISC) Machines (ARM) type processor environments. Various aspects of the present disclosure include an appreciation that ARM type processor environments can include a basic input output system (BIOS) which is implemented according to the Unified Extensible Firmware Interface (UEFI). Various aspects of the present disclosure include an appreciation that with certain ARM type processor environment implementations certain hardware dependencies can cause delayed secure boot path access even if the ARM type processor implementation includes a trust zone execution environment (TZEE). Various aspects of the present disclosure include an appreciation that with certain ARM type processor implementations, the secure boot path access can be delayed until the system boots the operating system.

Various aspects of the present disclosure include an appreciation that certain boot-time processor environment agnostic boot protocols can present security vulnerabilities which extend across processor environments. For example, certain x86 type security vulnerabilities can also be present in ARM type processor environments due to processor environment agnostic firmware unification. Various aspects of the present disclosure include an appreciation that often with processor environment agnostic firmware unification, certain security context content may not be processed.

Various aspects of the present disclosure include an appreciation that often DXE Services, such as UEFI services, are tightly coupled with a system management basic input/output system (SMBIOS) architecture of the processor environment. Various aspects of the present disclosure include an appreciation that certain unified SMBIOS implementations can bypass dynamic loading of a processor environment trust zone. For example, with certain processor environment implementations, memory corruption has occurred. while processing a command to pass a buffer such as a finish_sign command to pass a rsp buffer. Also, with certain processor environment implementations, a buffer over-read error has occurred when operating in a processor environment trusted execution environment mode of operation. Also, with certain processor environment implementations, memory corruption has occurred within a processor core due to a stack-based buffer overflow condition.

Various aspects of the present disclosure include an appreciation that with certain processor environments, pre-boot DXE phase services might not proceed to a security processor of the processor environment. Various aspects of the present disclosure include an appreciation that with certain processor environments trust zone extinction can occur which can lead to security vulnerabilities. Various aspects of the disclosure include an appreciation that with certain unified processor environment agnostic firmware implementations, x86 processor type features are often directly ported to ARM type processors, potentially negatively impacting or not executing ARM type processor pre-boot security features. Various aspects of the disclosure include an appreciation that this issue could potentially allow malicious code to execute unchecked whether the malicious code attempts to execute during pre-boot processes, in the operating system, or a combination thereof. Various aspects of the disclosure include an appreciation that with certain unified processor environment agnostic firmware implementations, there is no mechanism to generate an exception should any malicious code be detected.

Various aspects of the present disclosure include an appreciation that certain processor environments can have boot path vulnerability that could permit a malicious attack during a handoff operation. Various aspects of the present disclosure include an appreciation that a security attack could occur during a handoff between an SEC phase and a DXE phase. Various aspects of the present disclosure include an appreciation that such an attack could cause a particular device to stop functioning which could lead to an inability of the particular device to recover, even from a hardware reset, possibly requiring an engineering procedure for recovery. Various aspects of the present disclosure include an appreciation that certain processor environment compromises of a secure execution environment (such as those occurring during DXE/SMM/OS-RT phases) as well as secure boot bypasses are dangerous scenarios which can require system suppliers to manage firmware vulnerability releases. Various aspects of the present disclosure include an appreciation that processor environment vendors cannot generate firmware vulnerability releases for non-supportive boot modes, such as boot modes using UEFI services.

A system and method are disclosed for performing a boot process secure execution environment operation. In certain embodiments, the boot process secure execution environment operation includes an extended trust enclave operation. In certain embodiments, the boot process secure execution environment operation provides a processor environment context aware security environment. In certain embodiments, the processor environment context away security environment includes a seamless UEFI DXE phase load and dispatch operation. In certain embodiments, the seamless UEFI DXE phase load and dispatch operation provides platform boot path security for DXE services. In certain embodiments, the platform boot path security for DXE services is provided via a trust zone. In certain embodiments, the trust zone is instantiated in a system management BIOS (SMBIOS). In certain embodiments, the trust zone is instantiated in the SMBIOS via an embedded controller.

In certain embodiments, the platform boot path security includes memory overflow protection, NVRAM protection, stack buffer overflow protection, or a combination thereof. In certain embodiments, the trust zone provides security protection for volatile memory maps, non-volatile memory maps, or a combination thereof. In certain embodiments, the trust zone provides memory map protection as a seamless memory partition. In certain embodiments, the memory map protection is provided at a pre-boot SEC phase, a pre-boot PEI phase, a pre-boot DXE phase, or a combination thereof.

In certain embodiments, the boot process secure execution environment operation seamlessly protects ARM type processor environments from boot path vulnerabilities. In certain embodiments, the ARM type processor environments are protected from boot path vulnerabilities without the need for information handling system supplier customized security vulnerability releases.

In certain embodiments, the boot process secure execution environment operation includes an ARM processor environment specific security protocol. In certain embodiments, the ARM processor environment specific security protocol provides peripheral firmware driver security measurements. In certain embodiments, the ARM processor environment specific security protocol configures an embedded controller to function as a master device and configures one or more peripheral devices as slaved devices. In certain embodiments, the embedded controller maintains a root of trust. In certain embodiments, the root of trust is used by the one or more peripheral devices.

In certain embodiments, the boot process secure execution environment operation includes a trusted computing group (TCG)-Complaint adhere protocol. In certain embodiments, the TCG-Compliant adhere protocol detects vulnerable code and generates exception handlers used in performance of pre-boot security operations. In certain embodiments, the TCG -compliant adhere protocol operates during a pre-boot DXE phase so as to avoid vulnerable code from executing during the pre-boot DXE phase.

In certain embodiments, the boot process secure execution environment operation provides an extended trusted enclave (ETE). In certain embodiments, the extended trusted enclave improves security during pre-boot and operating system run time. In certain embodiments, the extended trusted enclave improves security of ARM type processor environments during pre-boot and operating system run time. In certain embodiments, the extended trust zone enclave enables secure boot path access for Unified Extensible Firmware Interface (UEFI) services executing during a Driver eXecution Environment (DXE) pre-boot phase

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

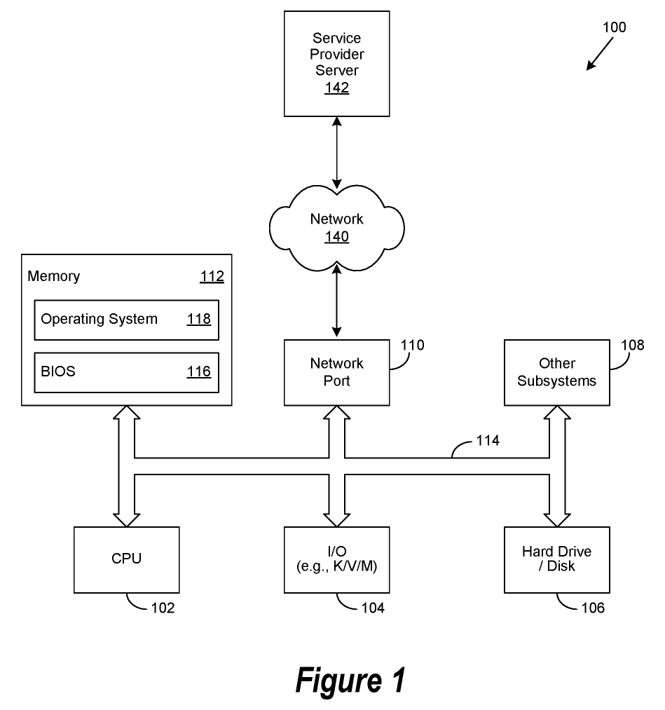

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS’s 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS’s 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS’s 100 initialization and startup within an .efi file, rather than on its associated firmware. In typical implementations, the .efi file may be stored on a special memory partition known as an EFI System Partition (ESP), which also contains the IHS’s 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein. In certain embodiments, the distributed BIOS 116 may be implemented as a distributed unified BIOS. As used herein, a distributed unified BIOS 116 broadly refers to a BIOS 116 that includes a plurality of BIOS 116 components, or a plurality of BIOS 116 variables, or a plurality of BIOS 116 storage locations, or a combination thereof, which are implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In various embodiments, the firmware management operation may be implemented to include the performance of a boot process secure execution environment operation.

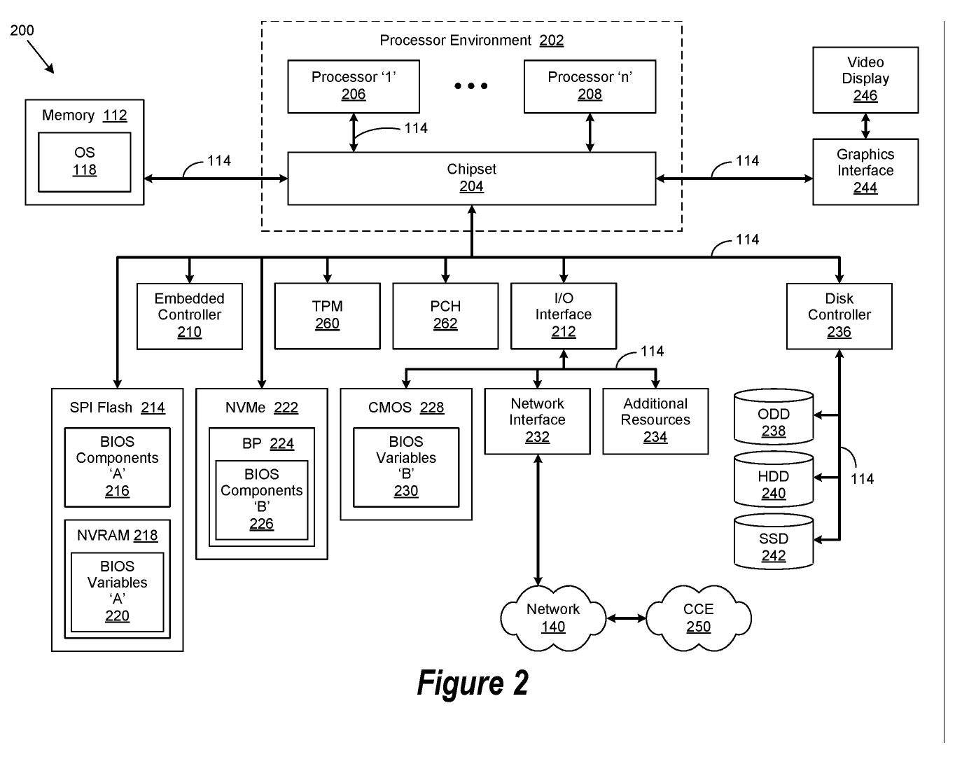

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as an information handling system (IHS), described in greater detail herein, such as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an Advanced Reduced Instruction Set Computer (RISC) Machines (ARM) type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented as a Graphics Processing Unit (GPU), familiar to skilled practitioners of the art. In various embodiments, the chipset 202, one or more of the processors ‘1’ 206 through ‘n’ 208, or a combination thereof may be implemented to include a security processor. In various embodiments, the chipset 202, one or more of the processors ‘1’ 206 through ‘n’ 208, or a combination thereof, may be implemented to include an ARM type security processor when the processor architecture is implemented as an ARM type processor architecture.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft^{®} Windows^{®}, while processor ‘n’ 208 may be implemented to run a version of Linux^{®}.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

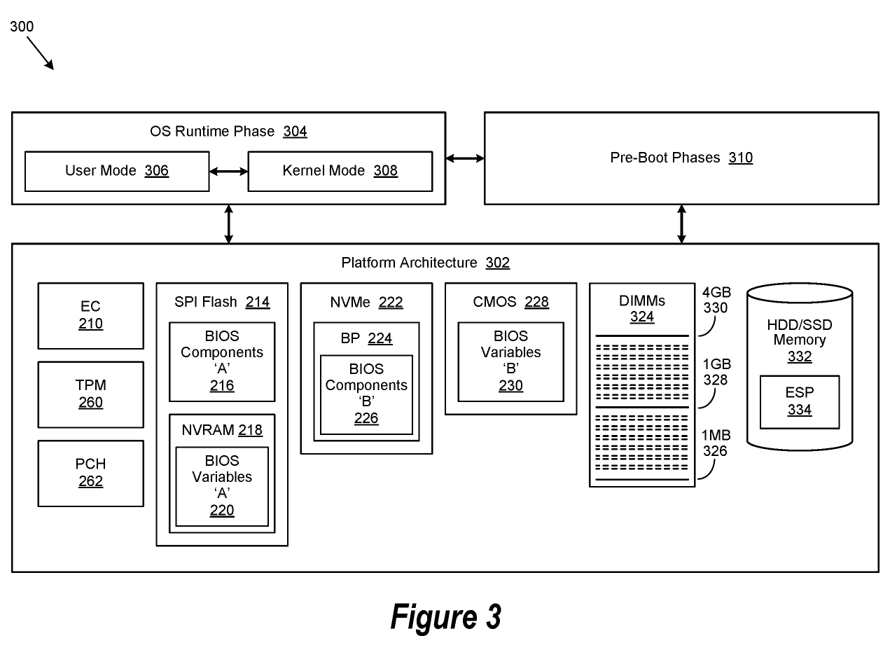

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS’s may utilize different processors (e.g., Intel^{®}, AMD^{®}, Qualcom^{®}, Broadcom^{®}, NVidia^{®}, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, each of which may be considered a component of an information handling system (IHS), as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel^{®} to control certain data paths and support functions used in conjunction with Intel^{®} processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel^{®}, AMD^{®}, Qualcomm^{®}, Broadcom^{®}, NVidia^{®}, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1GB 328 to 4GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS’s that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

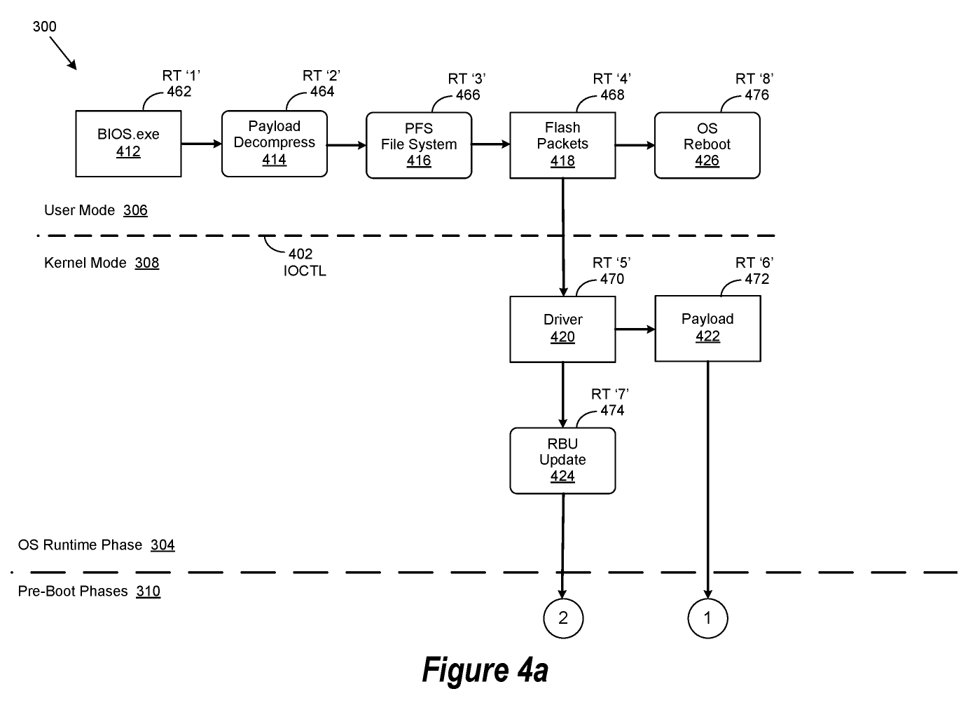

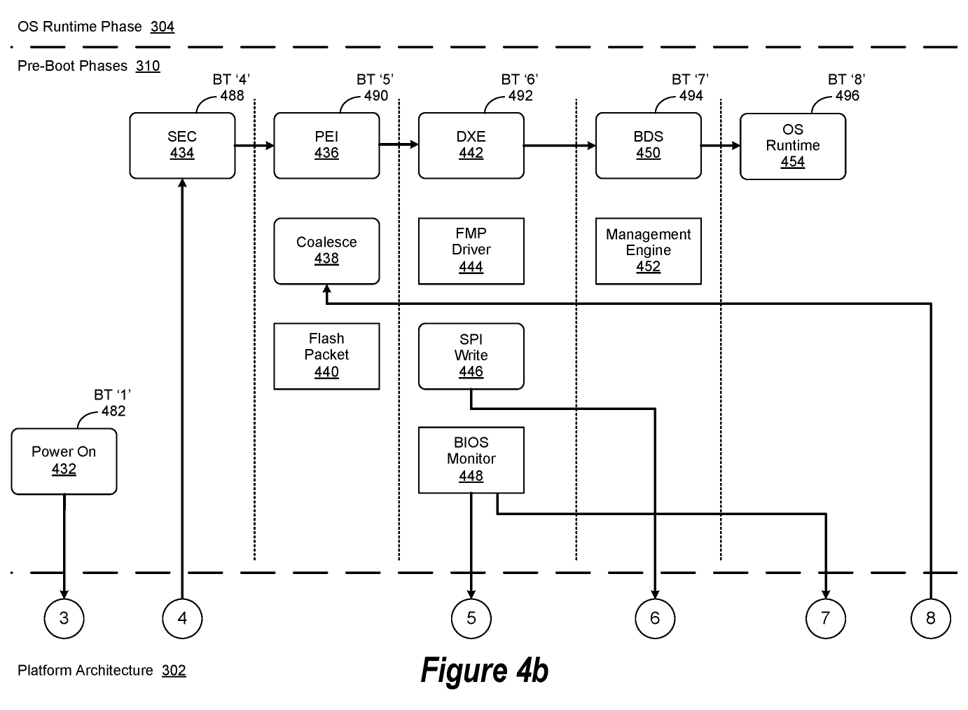

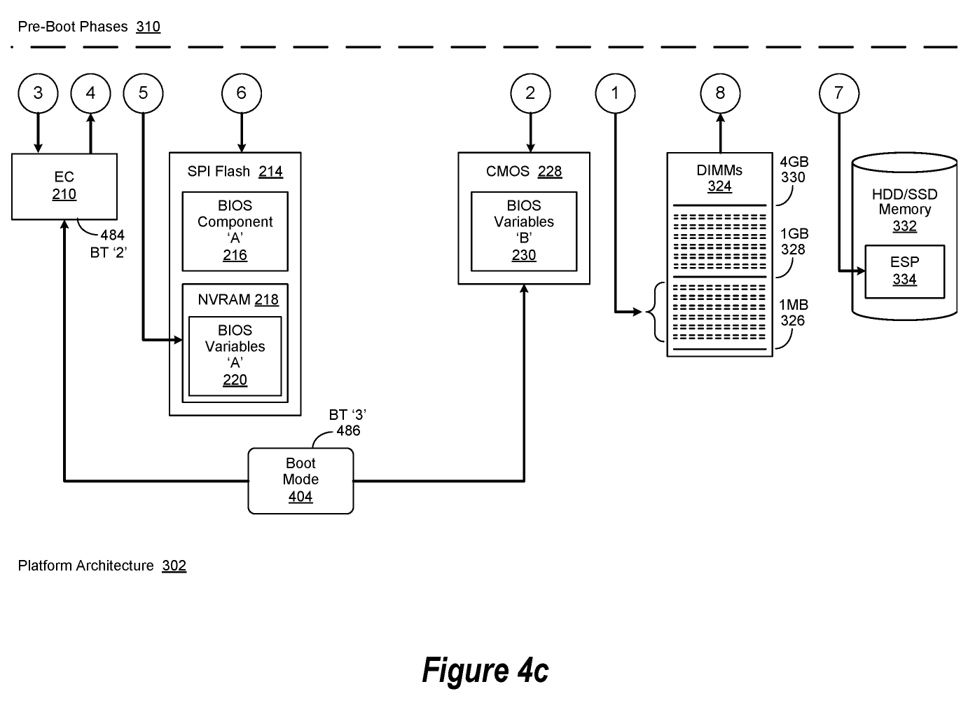

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system’s (IHS’s) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one of more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6’ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS’s processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell^{®} Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel^{®} Corporation of Santa Clara, California, may be implemented to use the selected boot device in BT step ‘8’ 496 to boot the ASDFMP 300 into an OS runtime 454 state.

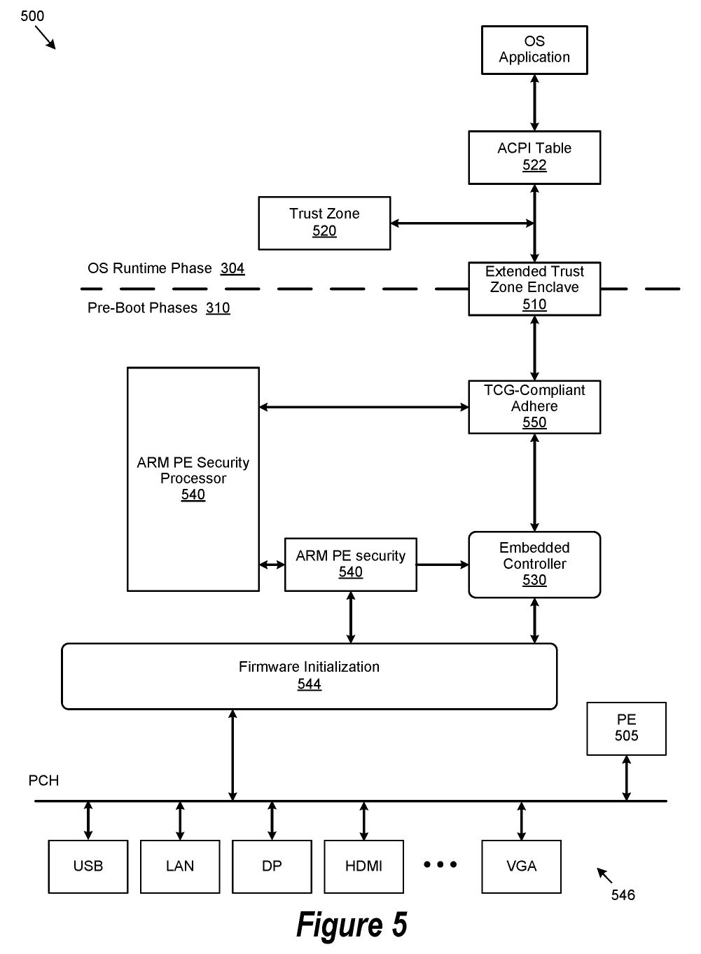

FIG. 5 shows a simplified block diagram of a boot process secure execution environment system 500 of an information handling system (IHS). In certain embodiments, the boot process secure execution environment system 500 is included within an information handling system such as information handling system 100. In certain embodiments, the boot process secure execution environment system 500 is included within a multi-processor operating environment such as multi-processor operating environment 200. In certain embodiments, the boot process secure execution environment system 500 includes a platform architecture 302.

In certain embodiments, the boot process security execution environment system performs a boot process secure execution environment operation. In certain embodiments, the boot process secure execution environment operation enables context aware DXE phase security alignment with an ARM trust zone to provide secure UEFI firmware services. In certain embodiments, the firmware services are associated with an ARM type processor environment 505. As used herein, context awareness broadly refers to a capability of the ASDFMP 300 to sense and react based upon information associated with the information handling system environment. As used herein, adaptive context awareness broadly refers to a capability of the ASDFMP 300 to sense and react based upon information associated with the information handling system environment which adjusts based upon one or more conditions associated with the information handling system environment.

In certain embodiments, the boot process secure execution environment operation enables processor environment agnostic firmware unification. As used herein, processor environment agnostic firmware unification broadly refers to providing one or more firmware components where the one or more firmware components are implemented to function with any of a plurality of processor environments, described in greater detail herein, including ARM type processor environments. In certain embodiments, processor environment agnostic firmware unification is accomplished via a unified BIOS such as distributed unified BIOS 116.

In certain embodiments, the boot process secure execution environment operation is performed by the boot process secure execution environment system 500. As used herein, a boot process secure execution environment operation broadly refers a firmware management operation, described in greater detail herein, performed, directly or indirectly, within a multi-processor operating environment 200 to establish a processor environment agnostic security environment that adapts to specific characteristics of a plurality of processor environment architectures.

In certain embodiments, the boot process secure execution environment operation includes an extended trust enclave operation. As used herein, an extended trust enclave operation broadly refers to a firmware management operation, described in greater detail herein, performed, directly or indirectly, within a multi-processor operating environment 200 to establish an extended trust enclave (ETE) 510. As used herein, an extended trust enclave broadly refers a set of security resources maintained in the same security domain to establish a single common, continuous security perimeter. In certain embodiments, the extended trust enclave functions as security barrier between the trust zone 520 and the ACPI Table 522. In certain embodiments, the extended trust enclave 510 includes trusted enclave services which allow direct communication from the embedded controller 530 to the ACPI Table 522. In certain embodiments, communication between the processor environment 505 and an application 524 is via the extended trust enclave 510, the ACPI Table 522, or a combination thereof. In certain embodiments, the extended trusted enclave 510 improves security during pre-boot and operating system run time. In certain embodiments, the extended trusted enclave 510 improves security of ARM type processor environments during pre-boot and operating system run time. In certain embodiments, the extended trusted enclave 510 enables secure boot path access for Unified Extensible Firmware Interface (UEFI) services executing during a Driver eXecution Environment (DXE) pre-boot phase.

In certain embodiments, the boot process secure execution environment operation provides a processor environment context aware security environment. In certain embodiments, the processor environment context away security environment includes a seamless UEFI DXE phase load and dispatch operation. As used herein, the seamless UEFI DXE phase load and dispatch operation broadly refers to a firmware management operation, described in greater detail herein, performed, directly or indirectly, within a multi-processor operating environment 200 to provide platform boot path security for DXE services. In certain embodiments, some or all of the platform boot path security for DXE services is provided via the trust zone 520. In certain embodiments, the trust zone is instantiated in a system management BIOS (SMBIOS). In certain embodiments, the trust zone 520 is instantiated in the SMBIOS via the embedded controller 530.

In certain embodiments, the platform boot path security includes memory overflow protection, NVRAM protection, stack buffer overflow protection, or a combination thereof. In certain embodiments, the trust zone provides security protection for volatile memory maps, non-volatile memory maps, or a combination thereof. In certain embodiments, the trust zone 520 provides memory map protection as a seamless memory partition. In certain embodiments, the memory map protection is provided at a pre-boot SEC phase, a pre-boot PEI phase, a pre-boot DXE phase, or a combination thereof.

In certain embodiments, the boot process secure execution environment operation seamlessly protects ARM type processor environments from boot path vulnerabilities. In certain embodiments, the ARM type processor environments are protected from boot path vulnerabilities without the need for information handling system supplier customized security vulnerability releases.

In certain embodiments, the boot process secure execution environment operation includes an ARM processor environment specific security protocol 540. As used herein, an ARM processor environment specific security protocol broadly refers to a standardized set of rules for formatting and processing data used in the performance of an ARM processor environment specific security operation. In certain embodiments, the ARM processor environment specific security protocol 540 is used when communicating with an ARM type security processor 542, an application, any of a plurality of processor components (such as the components described with respect to the multi-processor operating environment in FIG. 2), any of a plurality of peripheral components, or a combination thereof, regarding security information associated with the performance of an ARM processor environment specific security operation. In certain embodiments, the ARM processor environment specific security operation provides peripheral firmware driver security measurements. In certain embodiments, the peripheral firmware driver security measures are identified during a firmware initialization operation 544. In certain embodiments, the ARM processor environment specific security operation configures the embedded controller 530 to function as a master device and configures one or more peripheral devices as slaved devices. In certain embodiments, the embedded controller 530 maintains a root of trust. In certain embodiments, the root of trust is used by the one or more peripheral devices.

In certain embodiments, the boot process secure execution environment operation includes a trusted computing group (TCG)-Complaint adhere protocol 550. As used herein, TCG-Compliant adhere protocol broadly refers to a standardized set of rules for formatting and processing data used in the performance of a TCG-Compliant adhere operation. In certain embodiments, the TCG-Compliant adhere protocol 550 is used when communicating with an ARM type security processor 542, an application, any of a plurality of processor components (such as the components described with respect to the multi-processor operating environment in FIG. 2), any of a plurality of peripheral components, or a combination thereof, regarding security information associated with the performance of a TCG-Compliant adhere operation. In certain embodiments, the TCG-Compliant adhere operation detects vulnerable code and generates exception handlers used in performance of pre-boot security operations. In certain embodiments, the TCG -compliant adhere operation executes during a pre-boot DXE phase to avoid vulnerable code from executing during the pre-boot DXE phase.

In certain embodiments, the firmware initialization operation 544 initializes device drivers associated with one or more hardware peripherals, peripheral components, or a combination thereof, 546. In various embodiments, the hardware peripherals, peripheral components, or a combination thereof, 546 can include universal serial bus (USB) components, local area network (LAN) components, display port (DP) components, high definition multi-media interface (HDMI) components, video graphics array (VGA) components, etc. In certain embodiments, the processor environment 5050, the one or more hardware peripherals, peripheral components, or a combination thereof, 546, communicate via a Platform Controller Hub.

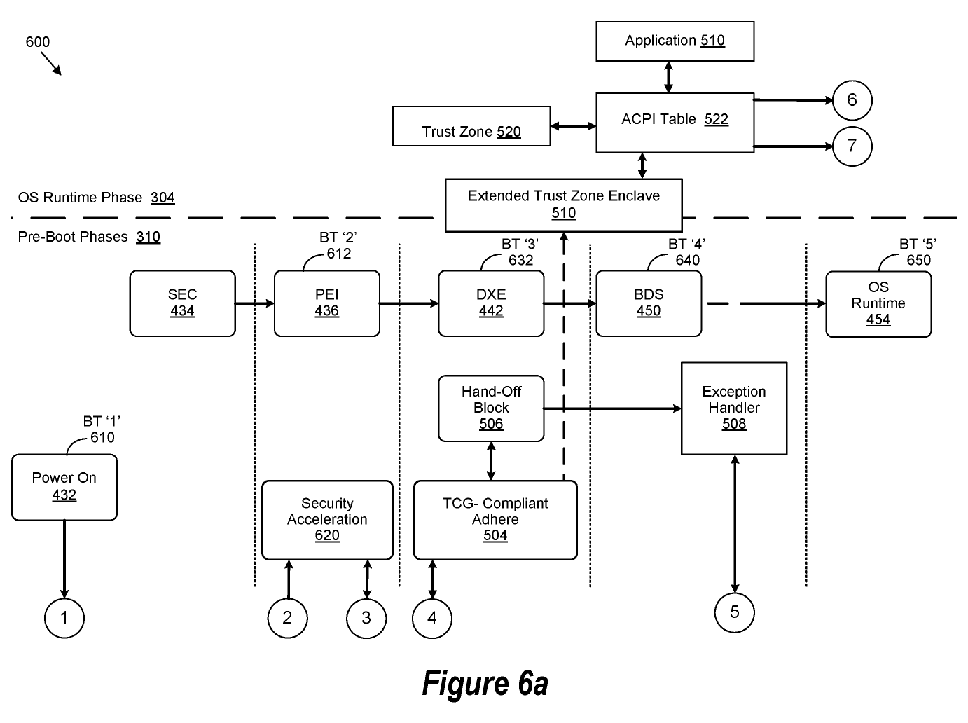

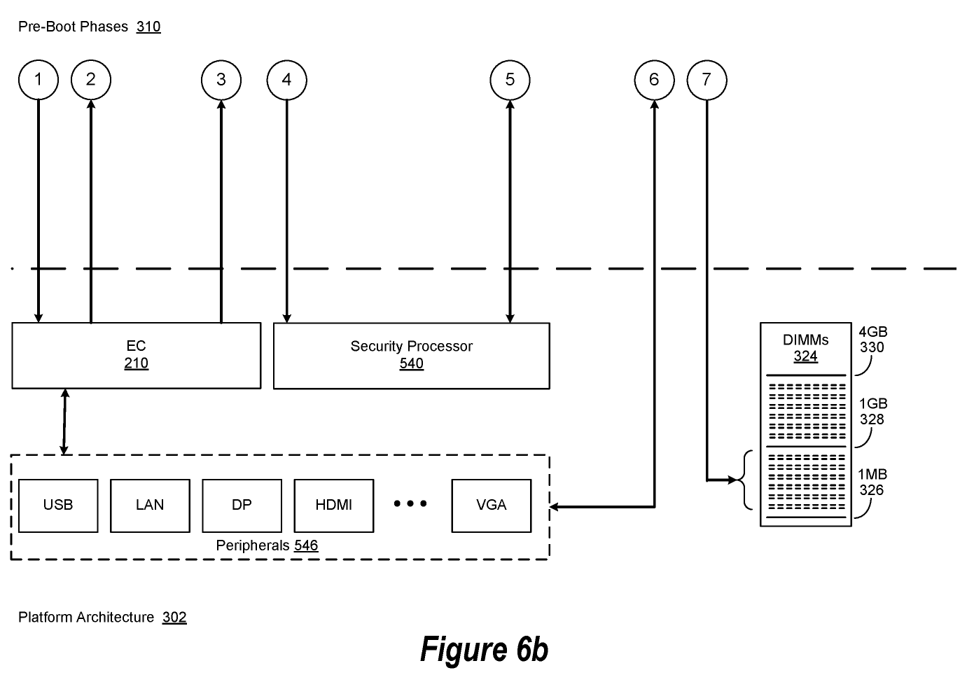

FIGS. 6a and 6b, generally referred to as FIG. 6, are a simplified block diagram showing an architecture-specific distributed firmware management platform (ASDFMP) implemented in accordance with an embodiment of the invention to perform a boot process secure execution environment operation 600. In various embodiments, the boot process secure execution environment operation 600 establishes a security environment that adapts to the specific characteristics of a particular processor environment architecture. boot process secure execution environment operation ensures that during the boot process, UEFI firmware can seamlessly load and dispatch DXE services while maintaining a secure platform boot path. In certain embodiments, the boot process secure execution environment operation 600 leverages trust zone technology to create a secure execution environment (SEE) for important boot processes, including DXE service initialization. Additionally, trust zone information may be used to provide additional context and security measures, such as verifying the integrity of hardware components and configurations. By integrating these elements, the boot process secure execution environment operation 600 enhances the overall security of the boot process, protecting against potential threats and ensuring the integrity of system operations from power-on to operating system execution.

By designating the embedded controller as the root of trust, embedded controller becomes the central authority for initiating and enforcing security measures throughout the information handling system. Additionally, configuring the embedded controller 210 as a master device provides the embedded controller with privileged access and control over other hardware peripherals and components 546 in the system. In various embodiments, the hardware peripherals and components 546 can include universal serial bus (USB) components, local area network (LAN) components, display port (DP) components, high definition multi-media interface (HDMI) components, video graphics array (VGA) components, etc. Additionally, by designating the embedded controller 210 as the root of trust, the embedded controller 210 can enforce security policies. In certain embodiments, the boot process secure execution environment operation 600 performs one or more security key measurement operations for one or more peripheral device drivers associated with respective peripherals 546.

More specifically, the boot process secure execution environment operation 600 starts at pre-boot time (BT) step ‘1’ 510 when power is applied 432 to the ASDFMP. Next at boot time (BT) step ‘2’ 612 peripheral device drivers are initialized to enable communication and functionality of hardware peripherals 546. In certain embodiments, the peripheral device drivers are initialized via a security acceleration operation 620 which interacts with the embedded controller 510. During the initialization, to ensure security for the peripheral device drivers, each peripheral device driver retrieves security key measurements using hash keys during initialization. In various embodiments, the security key measurements may include cryptographic hashes or signatures that verify the authenticity and integrity of the drivers, preventing tampering or unauthorized modifications. In certain embodiments, the security key measurement operations are performed during the SEC 434 phase.

In certain embodiments, when the boot process secure execution environment operation 600 completes an embedded controller security check during the PEI phase 436 and transfers control to the DXE 492 phase. Next, during pre-bot time (BT) step ‘3’ 632, the boot process secure execution environment operation 600 transfers control to an ARM type security processor 540. By transferring control to the ARM type security processor 540 in the DXE 492 phase and leveraging the seamless security acceleration protocol (which executed during the security acceleration operation 620) for driver authentication, the system enhances its security posture by verifying the integrity of critical components during the boot process. This comprehensive approach helps mitigate risk of unauthorized access, tampering, and malware infiltration, ensuring the overall security and trustworthiness of the system.

Using the ARM type security processor 540 allows authenticated drivers to pass the boot execution sequence to the trust zone 510. Additionally, the ARM type security processor 540 verifies any vulnerable code structure via the TCG-Compliant Adhere protocol 504. Additionally, in certain embodiments, when verifying each firmware driver structure code, the ARM type security processor 540 checks the authenticated drivers for any vulnerable code such as Memory leaks, buffer over-flow and not handling the function return statements. If any vulnerable code is detected, the ARM type security processor 540 generates an exception in pre-boot time (BT) step 4640. In certain embodiments, the exception is generated via an exception handler 508. In certain embodiments, the exception includes vulnerability information which enables a user to understand which part of the code, which driver, or a combination thereof, is responsible for generating the exception. After any exceptions are identified, generated, addresses, or a combination thereof, via the exception handler 508, the boot process secure execution environment operation 600 boots the ASDFMP 300 into an OS runtime 454 state in BT step ‘5’ 650.

In certain embodiments, the boot process secure execution environment operation 600 creates the extended trusted enclave (ETE) 510. In certain embodiments, the extended trusted enclave 510 is applied to one or more DXE services. In certain embodiments, the extended trust enclave 510 functions as a security barrier between the trust zone 520 and the ACPI Table 522. In certain embodiments, the extended trust enclave 510 includes trusted enclave services which allow direct communication from the embedded controller 210 to the ACPI Table 522. In certain embodiments, the extended trusted enclave 510 improves security during pre-boot 310 and operating system run time. In certain embodiments, the extended trusted enclave improves security of ARM type processor environments during pre-boot and operating system run time 304. In certain embodiments, the extended trusted enclave 510 enables secure boot path access for Unified Extensible Firmware Interface (UEFI) services executing during a Driver eXecution Environment (DXE) pre-boot 442 phase.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is

1. A computer-implementable method for performing a firmware management operation, comprising:
providing an information handling system with a distributed unified BIOS;
identifying a processor environment installed on an information handling system from a plurality of processor environments, the processor environment comprising a processor architecture; and,
performing a boot process secure execution environment operation, the boot process secure execution environment operation providing a processor environment context aware security environment.

2. The method of claim 1, wherein:
the processor architecture includes an Advanced Reduced Instruction Set Computer (RISC) Machines (ARM) type processor architecture.

3. The method of claim 1, wherein:
the information handling system includes an embedded controller, the embedded controller being implemented to enable a root of trust.

4. The method of claim 3, wherein:
the information handling system includes a security processor; and,
the embedded controller is implemented to provide security information to the security processor.

5. The method of claim 1, wherein:
the boot process secure execution environment operation establishes an extended trusted enclave.

6. The method of claim 5, wherein:
the extended trusted enclave enables secure boot path access for Unified Extensible Firmware Interface (UEFI) services executing during a Driver eXecution Environment (DXE) pre-boot phase.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed unified BIOS;
identifying a processor environment installed on an information handling system from a plurality of processor environments, the processor environment comprising a processor architecture; and,
performing a boot process secure execution environment operation, the boot process secure execution environment operation providing a processor environment context aware security environment.

8. The system of claim 7, wherein:
the processor architecture includes an Advanced Reduced Instruction Set Computer (RISC) Machines (ARM) type processor architecture.

9. The system of claim 7, wherein:
the information handling system includes an embedded controller, the embedded controller being implemented to enable a root of trust.

10. The system of claim 9, wherein:
the information handling system includes a security processor; and,
the embedded controller is implemented to provide security information to the security processor.

11. The system of claim 7, wherein:
the boot process secure execution environment operation establishes an extended trusted enclave.

12. The system of claim 11, wherein:
the extended trusted enclave enables secure boot path access for Unified Extensible Firmware Interface (UEFI) services executing during a Driver eXecution Environment (DXE) pre-boot phase.

13. A non-transitory, computer-readable storage medium embodying computer program code, the computer program code comprising computer executable instructions configured for:
providing an information handling system with a distributed unified BIOS;
identifying a processor environment installed on an information handling system from a plurality of processor environments, the processor environment comprising a processor architecture; and,
performing a boot process secure execution environment operation, the boot process secure execution environment operation providing a processor environment context aware security environment.

14. The non-transitory, computer-readable storage medium of claim 13, wherein:
the processor architecture includes an Advanced Reduced Instruction Set Computer (RISC) Machines (ARM) type processor architecture.

15. The non-transitory, computer-readable storage medium of claim 13, wherein:
the information handling system includes an embedded controller, the embedded controller being implemented to enable a root of trust.

16. The non-transitory, computer-readable storage medium of claim 15, wherein:
the information handling system includes a security processor; and,
the embedded controller is implemented to provide security information to the security processor.

17. The non-transitory, computer-readable storage medium of claim 13, wherein:
the boot process secure execution environment operation establishes an extended trusted enclave.

18. The non-transitory, computer-readable storage medium of claim 17, wherein:
the extended trusted enclave enables secure boot path access for Unified Extensible Firmware Interface (UEFI) services executing during a Driver eXecution Environment (DXE) pre-boot phase.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
